(19) United States
(12) Patent Application Publication
(10) Pub. No.: US 2025/0309729 A1
(43) Pub. Date: Oct. 2, 2025

(54) STATIONARY GENERATOR AND METHODS OF MAKING

(71) Applicant: Champion Power Equipment, Inc., Las Vegas, NV (US)

(72) Inventors: Greg Pauken, Hartland, WI (US); James J. Dehn, Brookfield, WI (US); Chris Despears, Menomonee Falls, WI (US); Leigh A. Jenison, Hartland, WI (US); Scott M. Stefaniak, Waukesha, WI (US)

(21) Appl. No.: 19/092,630

(22) Filed: Mar. 27, 2025

Related U.S. Application Data
(60) Provisional application No. 63/571,282, filed on Mar. 28, 2024.

(51) Int. Cl. H02K 7/18; F02B 63/04

(52) U.S. Cl. CPC H02K 7/1815; F02B 63/042; F02B 63/044

(57) ABSTRACT

A stationary generator includes a baseplate, an enclosure coupled to the baseplate, and an engine mounted on the baseplate. The stationary generator is free of an engine controller in communication with an automatic transfer switch (ATS).

### CROSS-REFERENCE TO RELATED APPLICATION

The present application is a non-provisional of, and claims priority to, U.S. Provisional Patent Application Ser. No. 63/571,282, filed Mar. 28, 2024, the disclosure of which is incorporated herein by reference in its entirety.

### BACKGROUND OF THE INVENTION

Embodiments of the present invention relate to generators and, more particularly, to a stationary generator and methods of making a stationary generator.

Home standby generators are well-known in the generator industry. However, in some cases, a home standby generator may be cost-prohibitive to a customer or provide more features or power than a customer needs. For example, a home standby generator will always include an automatic transfer switch (ATS), but a customer may not necessarily want such a feature.

It would therefore be desirable to provide to an alternative stationary, or non-portable, generator and methods of making the stationary generator.

### BRIEF STATEMENT OF THE INVENTION

In accordance with one aspect of the invention, according to one embodiment of the invention, a stationary generator includes a baseplate, an enclosure coupled to the baseplate, and an engine mounted on the baseplate. The stationary generator is free of an engine controller in communication with an ATS.

In accordance with another aspect of the invention, a method of manufacturing a stationary generator includes providing a baseplate; mounting an engine on the baseplate, the engine being free of an engine controller in communication with an ATS; and coupling an enclosure to the baseplate to cover the engine. A fuel tank assembly may be formed above the stationary generator thereby forming an upper panel of the enclosure with the fuel tank assembly.

In accordance with yet another aspect of the invention, a method of converting a portable generator to a non-portable generator meeting the UL2200 standard includes partially disassembling a portable generator; mounting an engine of the portable generator to a baseplate, the engine being free of an engine controller in communication with an ATS; and coupling an enclosure to the baseplate to cover the engine.

These and various other features and advantages of the present invention will be more readily understood from the following detailed description and the accompanying drawings.

### BRIEF DESCRIPTION OF THE DRAWINGS

The drawings illustrate embodiments presently contemplated for carrying out the invention.

In the drawings:

FIG. 1 is a front perspective view of a stationary generator, according to an embodiment of the invention.

FIG. 2 is a rear perspective view of the stationary generator of FIG. 1, according to an embodiment of the invention.

FIG. 3 is a top perspective view of the stationary generator of FIG. 1 without a fuel tank assembly, according to an embodiment of the invention.

FIG. 4 is a bottom perspective view of the stationary generator of FIG. 1 without a baseplate, according to an embodiment of the invention.

FIG. 5 is a front perspective view of the stationary generator of FIG. 1 without enclosure walls/panels, according to an embodiment of the invention.

FIG. 6 is a rear perspective view of the stationary generator of FIG. 1 without enclosure v, according to an embodiment of the invention.

FIG. 7 is a bottom perspective view of the stationary generator of FIG. 1 without enclosure walls/panels, according to an embodiment of the invention.

FIG. 8 is a top perspective view of the baseplate of the stationary generator of FIG. 1, according to an embodiment of the invention.

FIG. 9 is a front view of a control panel of the stationary generator of FIG. 1, according to an embodiment of the invention.

FIG. 10 is a rear view of the control panel of FIG. 9, according to an embodiment of the invention.

FIG. 11 is a rear perspective view of the control panel of FIG. 9, according to an embodiment of the invention.

FIG. 12 is a front perspective view of a fuel selector switch assembly of the control panel of FIG. 9, according to an embodiment of the invention.

FIG. 13 is a rear perspective view of the fuel selector switch assembly of FIG. 12, according to an embodiment of the invention.

FIG. 14 is a rear perspective view of a fuel selector switch and electrical switches of the fuel selector switch assembly of FIG. 12, according to an embodiment of the invention.

### DETAILED DESCRIPTION

Embodiments of the present invention relate to a stationary generator. The stationary generator includes a baseplate, an engine mounted on the baseplate, and an enclosure coupled to the baseplate and covering the engine. The stationary generator is free of an engine controller in communication with an ATS and therefore may include a manual transfer switch, but not an ATS. The stationary generator meets the UL2200 standard. The stationary generator may generally be coupled to one or more circuits or subpanels of a building, but may not be able power an entire building. An enclosure keeps the engine and associated components shielded from inclement weather such as rain. The gasoline fuel tank also forms the top panel of the enclosure.

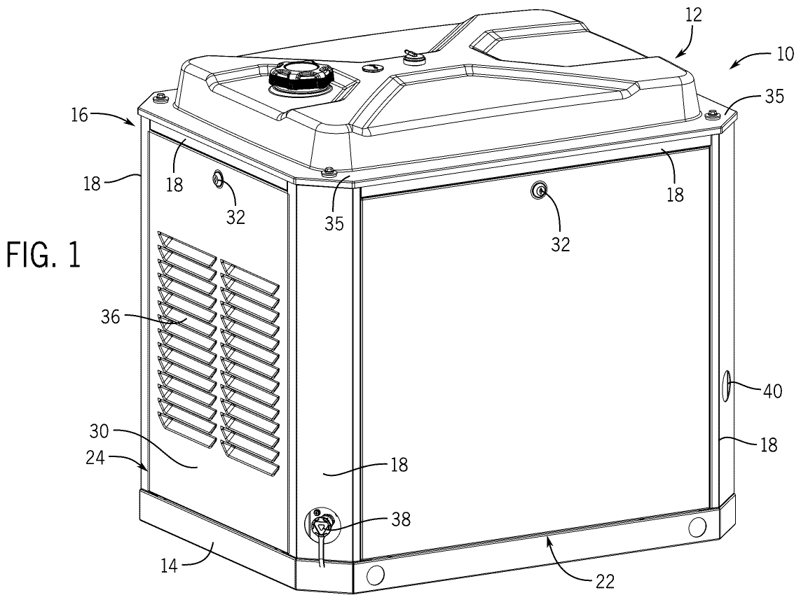

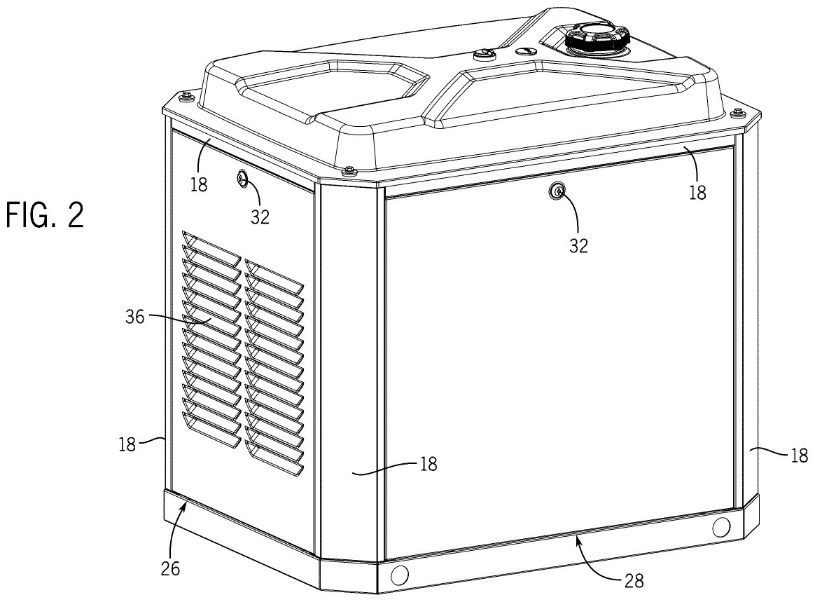

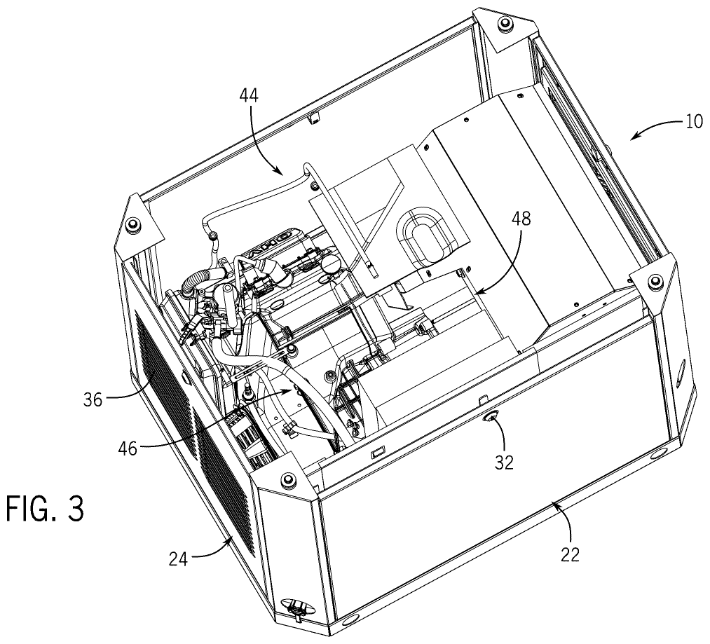

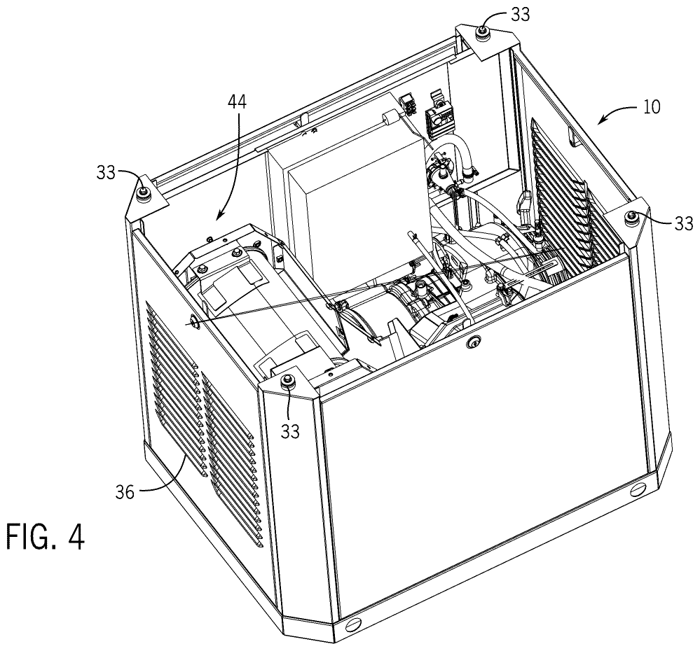

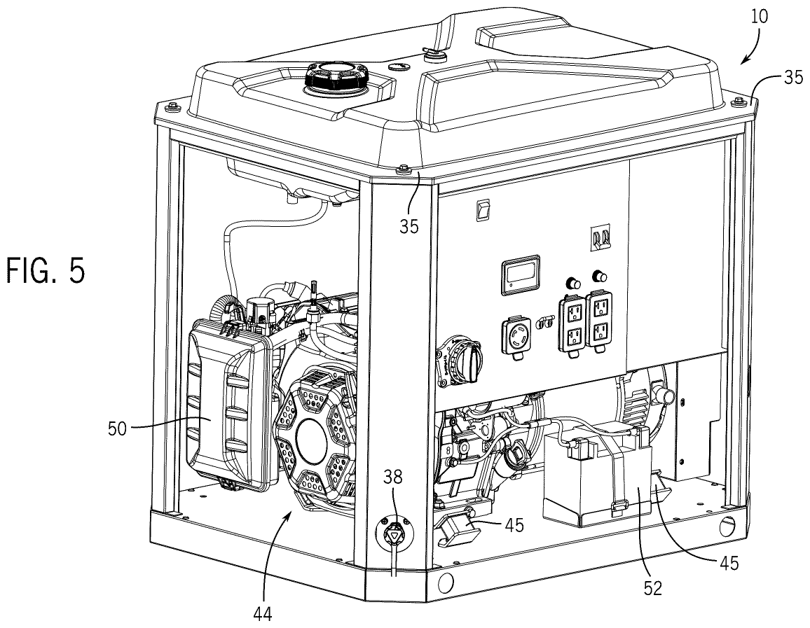

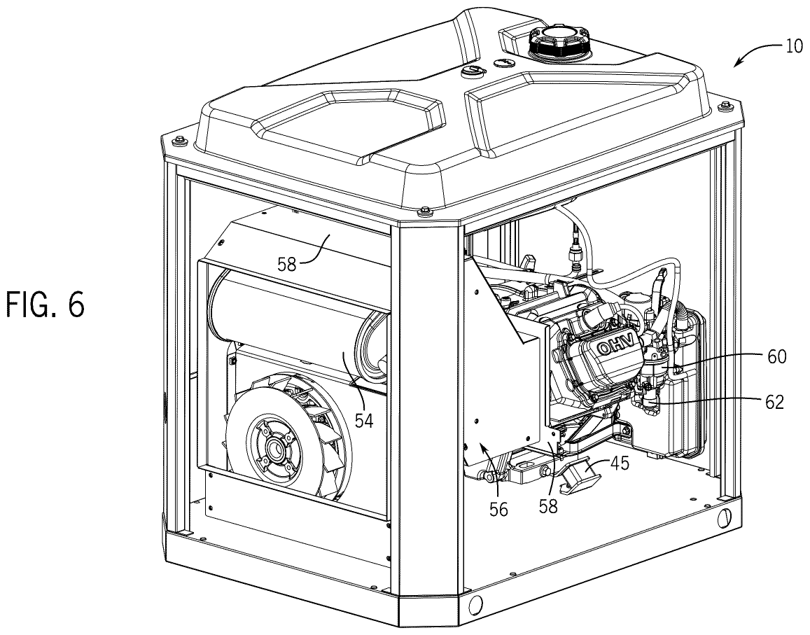

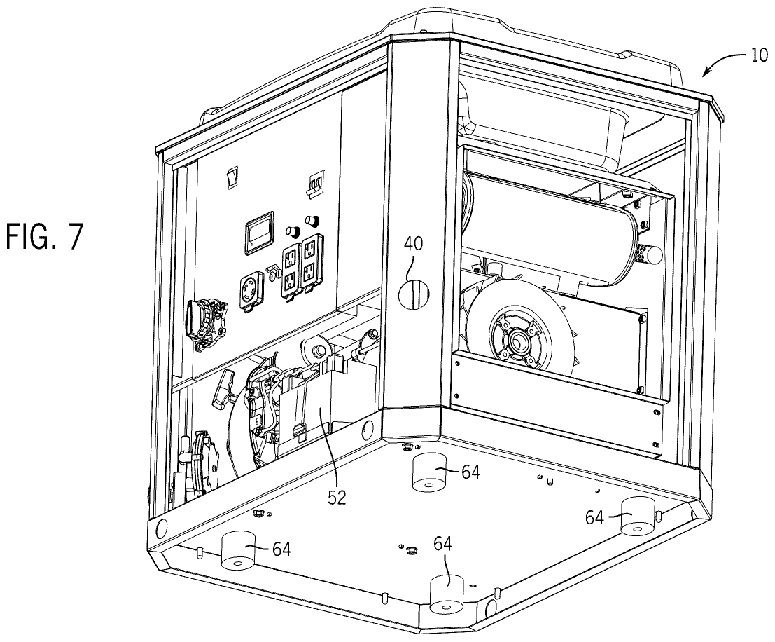

Referring to FIGS. 1-7, a stationary generator 10 is shown, according to an embodiment of the invention. In FIG. 3, stationary generator 10 is shown without a fuel tank assembly 12. In FIG. 4, stationary generator 10 is shown without a baseplate 14. In FIGS. 5-7, stationary generator 10 is shown without enclosure walls/panels of an enclosure 16.

Stationary generator 10 is typically a low-kilowatt generator when compared to a typical home standby generator.

Enclosure 16 includes a plurality of enclosure supports 18 which provides a frame for the enclosure panels 22, 24, 26, 28. Each one of the enclosure panels 22, 24, 26, 28 include a lock 32. For proper air flow, a plurality of ventilation louvres 36 may be added to enclosure panels 24 and 26. Additional ventilation louvres 36 may be added on any other panel as well. Fuel tank assembly 12 attaches to the enclosure supports 18 and forms the top panel of enclosure 16 and encapsulates the stationary generator 10 in a weather resistant enclosure 16. Enclosure 16 may include insulation for sound reduction as well.

Enclosure panels 22, 24, 26, 28 are each coupled to at least one enclosure support 18 via a lock 32 and may be opened and removed when unlocked. The fuel tank assembly 12 is connected to the enclosure supports with fasteners 33 that fit within openings 35 in fuel tank assembly 12 and are removable. The fuel tank assembly 12 forms the entirety of the top portion of enclosure 16. A non-removable portion of the stationary generator, such as the enclosure supports 18, may be used to hold a gaseous fuel connector 38 and an opening 40 for hard-wired electrical connections. A source of gaseous fuel, such as, for example, liquified petroleum gas (LPG) or natural gas (NG) may be connected to the gaseous fuel connector 38 and the electrical connections for the stationary generator 10 may pass through opening 40.

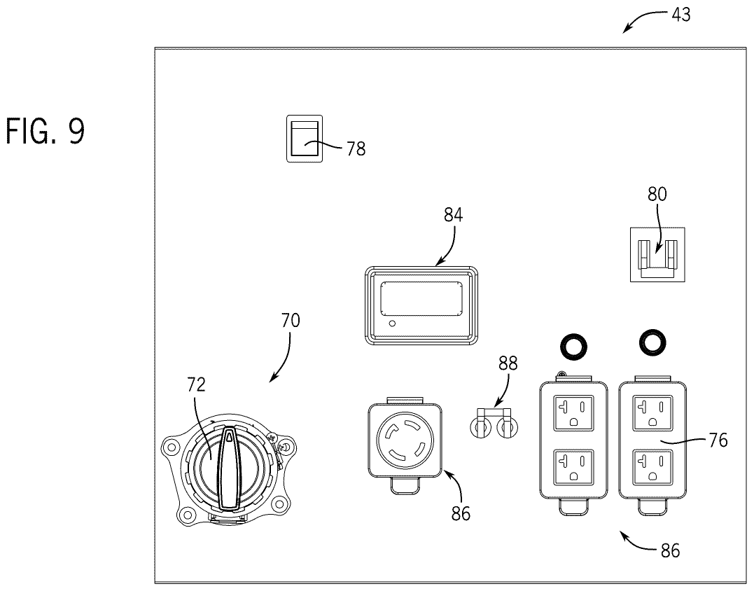

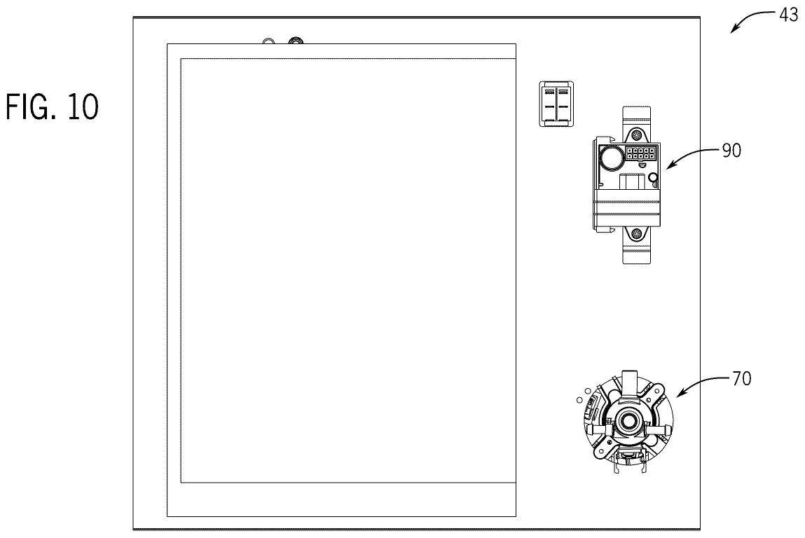

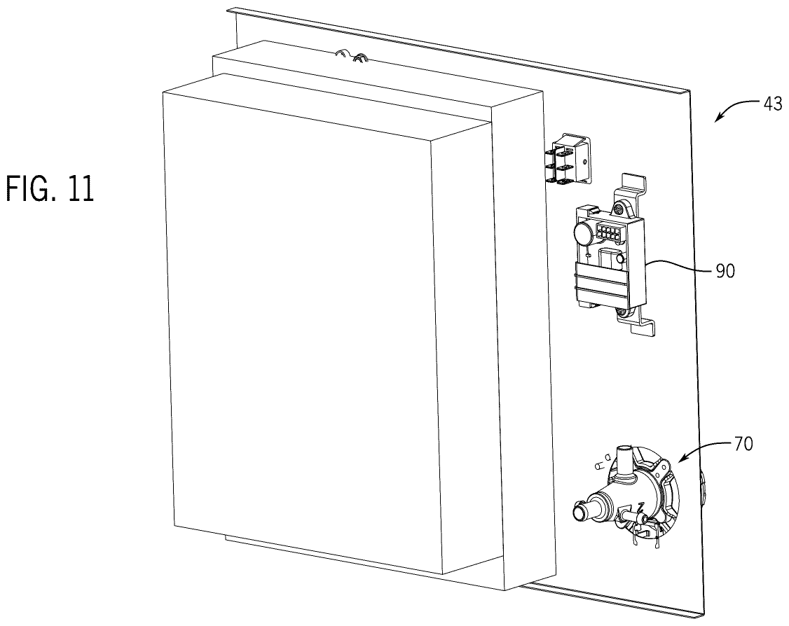

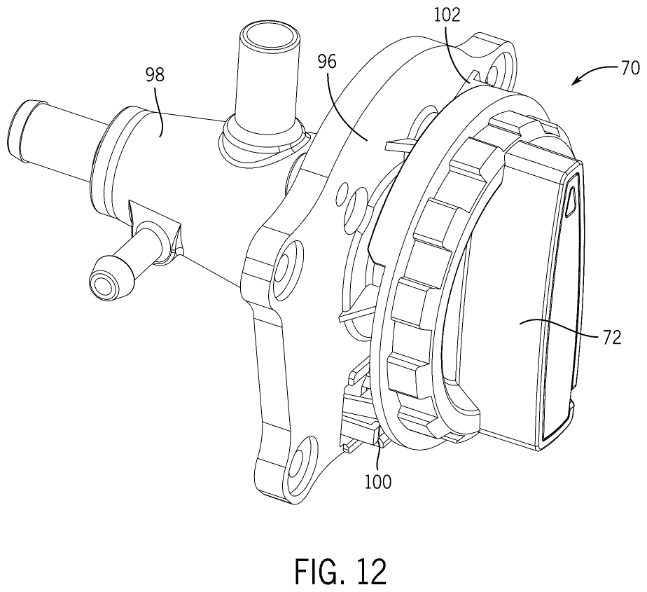

Stationary generator 10 includes a control panel 43 behind control enclosure panel 22 described in more detail with respect to FIGS. 9-14. Stationary generator 10 further includes a battery 52. Stationary generator 10 also includes an engine assembly 44 positioned within enclosure 16 and coupled to baseplate 14 via a plurality of mounts 45. Engine assembly 44 includes an engine 46 and an alternator 48 or another type of device for producing electricity coupled to engine for producing electrical power. Engine assembly 44 also includes an air filter 50, a muffler 54, a heatshield 56 coupled to base plate 14 including a plurality of walls 58. Stationary generator 10 and, more specifically, engine assembly 44 do not include an engine controller in communication with an ATS. As such, stationary generator 10 does not include an automatic transfer switch, but may include a manual transfer switch.

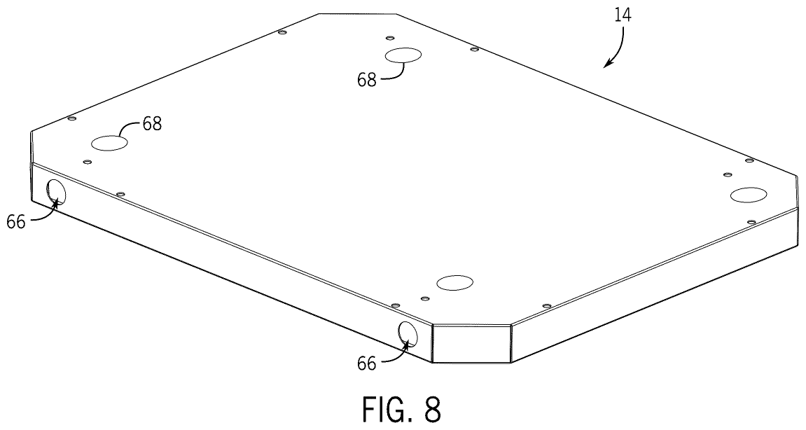

Referring now to FIG. 8, baseplate 14 of stationary generator 10 includes a plurality of carrying holes 66 for extending rods or pipes therethrough for carrying stationary generator 10 to where it will be installed. Baseplate 14 also includes a plurality of mounting holes 68 for mounting baseplate 14 during installation. Hurricane hold-downs 64 may be used in conjunction with mounting holes 68. Hurricane hold-downs 64 may be in the form of hurricane hold-down sleeves. A plurality of fasteners may be used to secure the baseplate 14 through the hurricane hold-downs 64 to a substrate such as a concrete pad, thereby securing the stationary generator 10 in place.

Referring to FIGS. 9-11, control panel 43 includes a fuel selector assembly 70 including a fuel selector switch or dial 72. Control panel 43 may include a choke control if needed (not pictured), an engine shutdown switch 78, pole switch 80, a display 84, a ground-fault circuit interrupter (GFCI) module 76, a plurality of outlets/receptacles 86, such as, for example, 5-20R and L14-30R receptacles, a GFCI circuit breaker 88, and power distribution block 90.

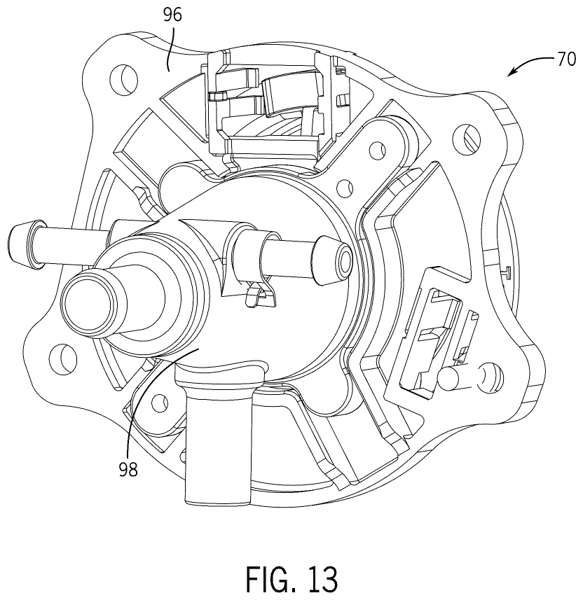

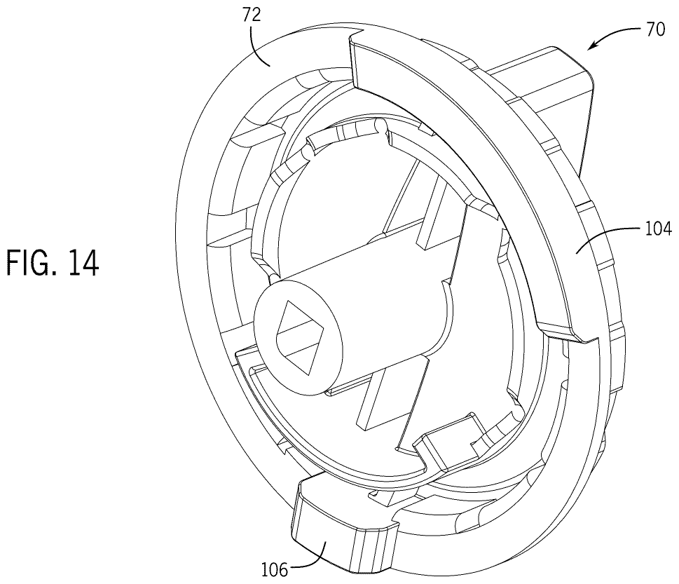

Referring now to FIGS. 13-14, fuel selector assembly 70 also includes a mounting plate 96 though which fuel selector switch 72 extends to a fuel valve 98 that couples to fuel tank assembly 12 to receive a liquid fuel, such as, for example, gasoline, and a gaseous fuel, such as, for example, LPG or NG, and two electrical switches 100, 102. Fuel selector switch 72 includes two ramps 104, 106 that interact with electrical switches 100, 102 to enable switching between fuels and preventing engine 46 from receive multiple fuels simultaneously. For example, one or both of electrical switches 100, 102 may trigger liquid fuel cut solenoid 62 on carburetor 60 of engine assembly 44. Fuel selector assembly 70 will generally include indications of which fuel is being selected (for example, gasoline, LPG, or NG) while fuel selector switch 72 is being rotated. Fuel selector switch 72 may have a position or mode for each applicable fuel and an OFF position or mode. Thus, as a non-limiting example, stationary generator 10 may have a Gasoline mode, an LPG mode, an NG mode, and an OFF mode.

Stationary generator 10 may be made by manufacturing stationary generator 10 with new parts in a manufacturing facility. However, stationary generator 10 may also be made by converting a portable generator to a non-portable or stationary generator by partially disassembling the portable generator and mounting the necessary components of the portable generator onto baseplate 14 and within enclosure 16. The fuel tank assembly 12 may also form the entire top panel of enclosure 16.

Beneficial embodiments of the invention thus provide a stationary, or non-portable, generator that includes a baseplate 14, an engine 46 mounted to the baseplate 14 without an engine controller in communication with an ATS, and an enclosure 16 coupled to the baseplate 14.

Therefore, according to one embodiment of the invention, a stationary generator 10 includes a baseplate 14, an enclosure 16 coupled to the baseplate 14, and an engine 46 mounted on the baseplate 14. The stationary generator 10 is free of an engine controller in communication with an ATS.

According to another embodiment of the invention, a method of manufacturing a stationary generator 10 includes providing a baseplate 10 and mounting an engine 46 on the baseplate 14. The engine 46 may be free of an engine controller in communication with an ATS. An enclosure 16 may be attached to the baseplate 14 to cover the engine 46. A fuel tank assembly 12 may also be formed above the engine 46, thereby forming an upper panel of the enclosure 16 with the fuel tank assembly 12.

According to yet another embodiment of the invention, a method of converting a portable generator to a non-portable generator is disclosed. The method includes meeting the UL2200 standard by partially disassembling a portable generator. The engine 46 from the portable generator may be mounted to a baseplate 14. The engine 46 may also be free of an engine controller in communication with an automatic transfer switch (ATS). An enclosure 16 may be affixed to the baseplate 14 to cover the engine 46.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. In the appended claims, the singular forms of “a,” “an,” and “the” include their corresponding plural references unless the context clearly dictates otherwise.

What is claimed is:

1. A stationary generator comprising:
a baseplate;
an enclosure coupled to the baseplate; and
an engine mounted on the baseplate;
wherein the stationary generator is free of an engine controller in communication with an automatic transfer switch (ATS).

2. The stationary generator of claim 1, further comprising a manual transfer
wherein the stationary generator is free of an ATS. switch;

3. The stationary generator of claim 1, further comprising a fuel tank assembly forming an upper panel of the enclosure above the engine.

4. The stationary generator of claim 1, wherein the stationary generator is equipped to operate on each one of gasoline, liquified petroleum gas (LPG), and natural gas (NG) in respective gasoline, LPG, and NG modes.

5. The stationary generator of claim 1, wherein the baseplate comprises:
a plurality of mounting holes; and
a hurricane hold-down for each mounting hole.

6. A method of manufacturing a stationary generator, the method comprising:
providing a baseplate;
mounting an engine on the baseplate, the engine being free of an engine controller in communication with an automatic transfer switch (ATS);
coupling an enclosure to the baseplate to cover the engine; and
forming a fuel tank assembly above the stationary generator thereby forming an upper panel of the enclosure with the fuel tank assembly.

7. The method of manufacturing a stationary generator according to claim 6, the method further comprising forming the enclosure from a plurality of enclosure panels and coupling a lock on each one of the enclosure panels thereby allowing the enclosure panels to be individually removable by unlocking the locks.

8. The method of manufacturing a stationary generator according to claim 6, the method further comprising concealing a control panel for the stationary generator behind an enclosure panel.

9. The method of manufacturing a stationary generator according to claim 7, the method further comprising forming a plurality of ventilation louvres on at least two of the enclosure panels.

10. The method of manufacturing a stationary generator according to claim 6, the method further comprising fastening the baseplate to a substrate with a plurality of fasteners thereby securing the stationary generator to the substrate.

11. The method of manufacturing a stationary generator according to claim 10, the method further comprising providing a plurality of hurricane hold-downs to secure the baseplate to the substrate with the plurality of fasteners.

12. The method of manufacturing a stationary generator according to claim 6, the method further comprising dismantling a portable generator and utilizing a plurality of components of the portable generator to manufacture the stationary generator.

13. The method of manufacturing a stationary generator according to claim 6, the method further comprising fastening the fuel tank assembly to a plurality of enclosure supports.

14. A method of converting a portable generator to a non-portable generator meeting the UL2200 standard, the method comprising:
partially disassembling a portable generator;
mounting an engine of the portable generator to a baseplate, the engine being free of an engine controller in communication with an automatic transfer switch (ATS); and
coupling an enclosure to the baseplate to cover the engine.

15. The method of converting a portable generator to a non-portable generator meeting the UL2200 standard according to claim 14, the method further comprising forming the enclosure from a plurality of enclosure panels and coupling a lock on each one of the enclosure panels thereby allowing the enclosure panels to be individually removable by unlocking the locks.

16. The method of converting a portable generator to a non-portable generator meeting the UL2200 standard according to claim 14, the method further comprising concealing a control panel for the stationary generator behind an enclosure panel.

17. The method of converting a portable generator to a non-portable generator meeting the UL2200 standard according to claim 14, the method further comprising forming a gasoline fuel tank assembly above the stationary generator thereby forming an upper panel of the enclosure with the fuel tank assembly.

18. The method of converting a portable generator to a non-portable generator meeting the UL2200 standard according to claim 14, the method further comprising:
fastening the baseplate to a substrate with a plurality of fasteners thereby securing the stationary generator to the substrate; and
providing a plurality of hurricane hold-downs to secure the baseplate to the substrate with the plurality of fasteners.

19. The method of converting a portable generator to a non-portable generator meeting the UL2200 standard according to claim 17, the method further comprising installing a carburetor configured to provide the engine with an amount of gasoline and liquid propane.

20. The method of converting a portable generator to a non-portable generator meeting the UL2200 standard according to claim 19, the method further comprising providing a fuel selector switch allowing for selection of a fuel source as the gasoline fuel tank or a remote liquid propane source.
